(19) United States
(12) Patent Application Publication
(10) Pub. No.: US 2020/0111012 A1
(43) Pub. Date: Apr. 9, 2020

(54) METHOD FOR COMPUTER SIMULATION OF HUMAN BRAIN LEARNING, LOGICAL REASONING APPARATUS AND BRAIN-LIKE ARTIFICIAL INTELLIGENCE SERVICE PLATFORM

(71) Applicant: HUNAN BENTI INFORMATION TECHNOLOGY RESEARCH CO. LTD., Changsha (CN)

(72) Inventor: Jihua WAN, Changsha (CN)

(21) Appl. No.: 16/655,550

(22) Filed: Oct. 17, 2019

Related U.S. Application Data
(63) Continuation of application No. PCT/CN2018/000143, filed on Apr. 17, 2018.

(30) Foreign Application Priority Data
Apr. 17, 2017 (CN) 201710247831.2

(51) Int. Cl. G06N 5/04; G06F 8/33; G06N 20/00; G06F 40/30; G06F 40/211; G06F 40/237

(52) U.S. Cl. CPC G06N 5/04; G06F 8/33; G06F 40/237; G06F 40/30; G06F 40/211; G06N 20/00

(57) ABSTRACT

The present disclosure provides a method for computer simulation of human brain learning knowledge, a reasoning apparatus, and a brain-like artificial intelligence service platform. The method includes: establishing a brain-like knowledge library, including a word library, a class library, a resource library, and an intelligent information management library; processing, by a semantic analyzer, a natural language single sentence to generate class basic elements and semantic properties in a manner of creating classes, and storing the class basic elements and the semantic properties in the class library; generating, by a semantic analyzer, the intelligent application program satisfying an intelligent application requirement based on the intelligent knowledge elements, and storing the intelligent application program in the intelligent information management library.

### FIELD

The present disclosure relates to the field of computers, and more particularly relates to a method for computer simulation of human brain learning knowledge, a logical reasoning apparatus and a brain-like artificial intelligence service platform.

### BACKGROUND

Artificial intelligence aims to enable machines to learn and work in a brain-like manner. To achieve this, it is necessary to artificially simulate cognitive model and intelligent mechanism of human brain to computers, that is, to allow the computers to process data information in the brain-like manner. However, logical formal system and mechanical computing capability proved by the Gödel's incompleteness theorem and the Turing's theorem limit the development of the brain-like artificial intelligence technology.

Generally speaking, the logical limitations proved by the Gödel's theorem and Turing's theorem are logical judgment on propositions in forms of positive and negative or true and false is algorithmically insoluble. However, the human brain cognition functions by logical judgment and reasoning, where the reasoning depends on the judgment. In contrary, computers are algorithmic machines, namely physical devices driven by algorithms. The human brain thinking based on the judgment is incalculable unless the judgment is implemented by an algorithm, also the human cognitive model and intelligent mechanism cannot be simulated to computers unless the thinking is implemented by a computable logical algorithm. Therefore, the key to the brain-like artificial intelligence lies in how to convert natural language into computer program language and how to simulate logical judgment and reasoning in program language.

In response to this, Jihua Wan published a paper “The Philosophy and Empirical Investigation of the Semantic Properties of Genes” on “Research on Dialectics of Nature” in 2006, in which there is proposed with an ontological information philosophy idea for solving the semantic ambiguity with essential uniqueness, and also proposed with that by extracting the semantic properties of propositions, the propositions can be logically judged for information entities, so as to eliminate the genetic quantum algorithm that forms the semantic paradox in Gödel's incompleteness theorem. Later, the author published a monograph “Principles and Applications of Ontology Logic” (by Guangdong Science and Technology Press in 2008), which systematically discussed how computers understand the ontological philosophy theory and logical computing technology of human natural language. In addition, a judgment method for truth table coded with quantum semantic signals of four genes is proposed. In October 2008, the author gave an academic report on “Truth-Value Calculation System Based on Philosophical Ontology-A Logical Method for Computers to Understand Natural Language” at the Fourth National Conference on Logic Systems, Intelligent Science and Information Science, and the report was compiled into the academic thesis of “Logic and Its Application Research” (published by Guizhou Nationalities Press in 2009). And in October 2016, the author was entitled to the grant of a Chinese patent “Method for Translating Natural Language to Computer Language, Semantic Processor and Human-Computer Dialogue System” (Patent No. ZL201310657042.8).

The above Chinese patent provides a method for translating natural language into computer language. Specifically, computers identify and extract grammatical components by using a word library and a word segmentation rule, logical conjunctions and logical semantics in the natural language; translate, based on an information management database, the grammatical components into string codes representing basic element names in computer object-oriented languages, logical conjunctions into program transfer instruction codes representing program control, and logical semantics into binary codes representing positive and negative; and concatenate these codes into programming languages. Since language is information tool and carrier for expressing human brain's cognition and thinking, translating natural language into computer language means that machines are capable of working based on instructions in natural sentences (propositions), means that machines are capable of interacting with humans with the natural language, and also means that the brain-like artificial intelligence can be realized.

However, the above Chinese patent fails to disclose computers how to learn knowledge and intelligently work and execute programs by judgment and reasoning, and thus fails to solve the problem of enabling computers to learn and work in the brain-like manner. As axiomatic algorithm for logical judgment and reasoning has been proven and improved, an artificial intelligence system can be developed based on the algorithm, so as to allow computers to learn and work in the brain-like manner.

### SUMMARY

To solve the above problem, the present disclosure provides a method for computer simulation of human brain learning knowledge, including the following operations:

(1) establishing a brain-like knowledge library, the brain-like knowledge library including a word library, a word library, a resource library, and an intelligent information management library; wherein:

the word library is configured to store words that represent scenes or events in natural language and part of speech corresponding to the words;

the class library is configured to store class basic elements corresponding to syntax components in natural language sentences and logical true sematic properties of the class basic elements; wherein: the natural language sentences comprise subject units and predicate units, and the class basic elements comprise objects and functions; the semantic property of the object element corresponding to the subject unit being positive is logical true, represented by a binary code 1; the semantic property of the function element corresponding to the predicate unit being either positive or negative is logical true, respectively represented by a binary code 1 or 0; the binary code 1 refers to that the positive is true, and the binary code 0 refers to that the negative is true;

the resource library is configured to store information resources of the scenes or the events, wherein the information resources correspond to the semantic properties of the class basic elements in the class library with logical true values; and

the intelligent information management library is configured to store a brain-like judgment and reasoning algorithm program and an intelligent application program, and a relation among the word library, the class library and the resource library;

(2) inputting the words representing grammatical components in the natural language sentences and the part of speech of the words in the word library; processing, by a semantic analyzer, a natural language single sentence to generate the class basic elements and the semantic properties in a manner of creating classes, and storing the class basic elements and the semantic properties in the class library; configuring the scenes corresponding to the class basic elements and the semantic properties, and storing the configured scenes in the resource library; wherein: the semantic properties of the objects and the functions being consistent with the properties of the corresponding scenes in the resource library is logical true; the property of the scene corresponding to the object element being positive is logical true, the property of the scene corresponding to the function element being either positive or negative is logical true; the function element that the semantic property is represented by the binary code of 1 corresponds to the scene that the property being positive is logical true, and the function element that the semantic property is represented by the binary code of 0 corresponds to the scene that the property being negative is logical true, so as to form a correspondence relationship between the subject and predicate units and the objects and functions; and

(3) generating, by the semantic analyzer, the intelligent application program satisfying an intelligent application requirement from a natural language program based on the class basic elements and the semantic properties in the class library, and storing the intelligent application program in the intelligent information management library.

Optionally, the word library includes a system word library, a private word library, and a public word library. The system word library is configured to store logical connectives and words with negative semantic properties. The private word library is configured to store user-defined words corresponding to the class library and the resource library in a specific field or block. The public word library is configured to store words with normative part of speech.

Optionally, the class library includes an ontology heterogeneous function. The ontology heterogeneous function is configured to correspond different words referring to a same scene as a same word.

The present disclosure also provides a logical reasoning apparatus, applied to the method for computer simulation of human brain learning knowledge, which can be realized in forms of software or/and hardware. The logical reasoning apparatus includes a knowledge information obtaining module, a judgment and reasoning calculating module, an operation program generating module and an operation program executing module. The knowledge information obtaining module is configured to obtain an application program stored in an intelligent information management library and an algorithm program that is configured to perform a judgment and reasoning calculation on the application program. The judgment and reasoning calculating module is configured to perform the judgment and reasoning calculation on the application program by using an obtained axiom algorithm program. The operation program generating module is configured to generate an executable judgment and reasoning conclusion program according to a result of a logical calculation. The operation program executing module is configured to execute the judgment and reasoning conclusion program.

Optionally, the judgment and reasoning algorithm program includes a judgment algorithm program and a reasoning algorithm program. The judgment algorithm program when being executed is configured to judge whether a binary code of the semantic property of the function in a single sentence program and a binary code of the logical property of the corresponding function in the class library are the same. If the two are the same, such as 00 or 11, the single sentence program is judged to be true and returns a value of 1, accordingly a judgment conclusion of the single sentence program with the return value of 1 is made based on the object, the function and the information resource of the corresponding scene, according to the original semantic property of the single sentence program. If the two are different, such as 01 or 11, the single sentence program is judged to be false and returns a value of 0, accordingly the judgment conclusion of the single sentence program with the return value of 0 is made based on the object, the function and the information resource of the corresponding scene, according to a semantic property after reversing the original semantic property of the single sentence program. In addition, the reasoning algorithm program is configured to derive a conclusion based on the return value of the single sentence program processed by the judgment algorithm program and logical connective relations, wherein the logical connective relations include a sufficient condition, a necessary condition, a necessary and sufficient condition, AND, and OR.

Optionally, the reasoning algorithm program when being executed to calculate the sufficient condition performs the following operations: if the antecedent is true, then determining the consequent to be true; if the antecedent is false, then determining the consequent to be true or false; if the consequent is true, then determining the antecedent to be true or false; and if the consequent is false, then determining the antecedent to be false. The reasoning algorithm program when being executed to calculate the necessary condition performs the following operations: if the antecedent is true, then determining the consequent to be true or false; if the antecedent is false, then determining the consequent to be false; if the consequent is true, then determining the antecedent to be true; and if the consequent is false, then determining the antecedent to be true or false. The reasoning algorithm program when being executed to calculate the necessary and sufficient condition performs the following operations: if the antecedent is true, then determining a consequent to be true; if the antecedent is false, then determining the consequent to be false; if the consequent is true, then determining the antecedent to be true; and if the consequent is false, then determining the antecedent to be false.

Optionally, the reasoning algorithm program when being executed to calculate the OR relation performs the following operations: if one of two single sentences is true, then determining the other one to be false; and if one of two single sentences is false, then determining the other one to be true.

Optionally, the reasoning algorithm program when being executed to calculate the AND relation performs the following operations: if each of single sentences in the antecedent is true, then determining the consequent to be true; and if one of the single sentences in the antecedent is false, then determining the consequent to be false.

Optionally, the operation program generating module is configured to generate an operation program according to a judgment and reasoning conclusion. The operation of generating the judgment generating program includes: in response to the program having a return value of true, generating the judgment operation program based on the object and the function in the class library, and the corresponding scene configured in the resource library, according to the original semantic property of the function defined in the application program; in response to the program having the return value of false, generating the judgment operation program based on the object and the function in the class library, and the corresponding scene configured in the resource library, according to a semantic property after reversing the semantic property of the function defined in the application program. If the program includes a plurality of statements, the statements are processed in a certain order to generate the judgment operation program. The operation of generating the reasoning generating program includes: dividing a reasoning application program into an analysis program statement and an operation program statement; wherein the analysis program statement is a program that derives a conclusion statement, and the operation program statement is a program that is derived as the conclusion. In particular, in response to the conclusion statement having a return value of true, generating the reasoning operation program based on the object and the function in the class library, and the corresponding scene configured in the resource library, according to the original semantic property of the function defined in the intelligent application program; in response to the conclusion statement having a return value of false, generating the reasoning operation program based on the object and the function in the class library, and the corresponding scene configured in the resource library, according to the semantic property after reversing the semantic property of the function defined in the intelligent application program; and in response to the conclusion statement having a return value of true or false, generating the reasoning operation program based on the object and the function in the class library, and the corresponding scene configured in the resource library, according to the original semantic property of the function defined in the intelligent application program or the semantic property after reversing the semantic property of the function defined in the intelligent application program.

The present disclosure also discloses a brain-like artificial intelligence service platform, using the logical reasoning apparatus, including:

(1) integrating a semantic analyzer, the method for computer simulation of human brain learning knowledge, and the logical reasoning apparatus into an intelligence operating system based on natural language analyzer, and developing the brain-like artificial intelligence service platform, to provide network sharing brain-like service;

(2) downloading, by an artificial intelligence application developer, a toolkit from the brain-like artificial intelligence service platform, establishing or updating the brain-like knowledge library and an application program by applying the method for computer simulation of human brain learning;

(3) sending, by an end user, an application request or instruction to the brain-like artificial intelligence service platform in natural language based on an application product of the artificial intelligence developer;

(4) obtaining, by the brain-like artificial intelligence service platform, the natural language input by the end user, and generating the application request or instruction defined by the artificial intelligence application developer by calling the semantic analyzer; and

(5) processing, by the logical reasoning apparatus, the intelligent application program satisfying a requirement of the end user, so as to finish human-machine interaction.

From above, the present disclosure provides a method for computer simulation of human brain learning knowledge, which enables computers to learn knowledge in a brain-like manner. The present disclosure also provides a logical reasoning apparatus capable of performing the judgment and reasoning calculation. In the present disclosure, the cognitive model of human brain understanding objective things and the intelligent mechanism based on the cognitive model can be simulated to computer systems, which allows computers to learn and work in the brain-like manner, thereby forming a brain-like artificial intelligence service platform.

### BRIEF DESCRIPTION OF THE DRAWINGS

FIG. 1 is a diagram illustrating a method for computer simulation of human brain learning knowledge in the present disclosure;

FIG. 2 is a diagram illustrating a logical reasoning apparatus in the present disclosure;

FIG. 3 is a flowchart diagram illustrating a brain-like artificial intelligence service platform in the present disclosure.

### DETAILED DESCRIPTION OF THE EMBODIMENTS

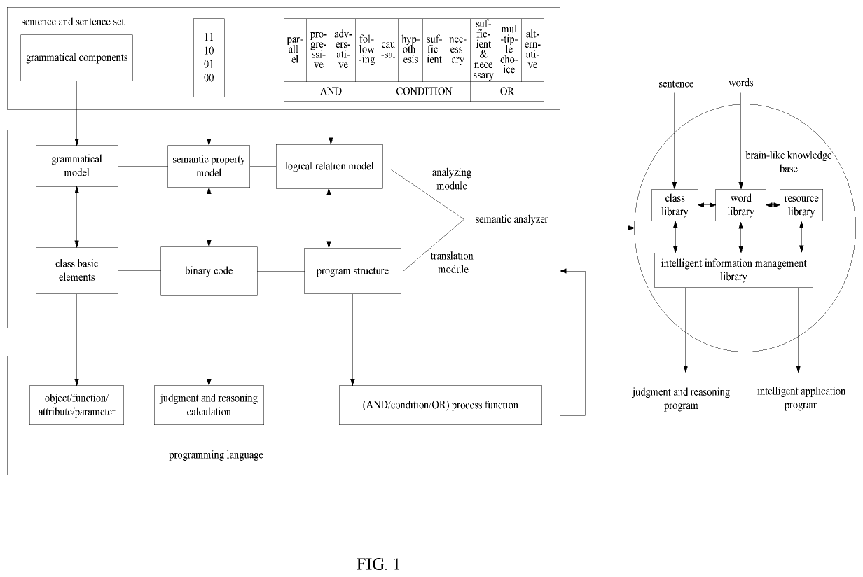

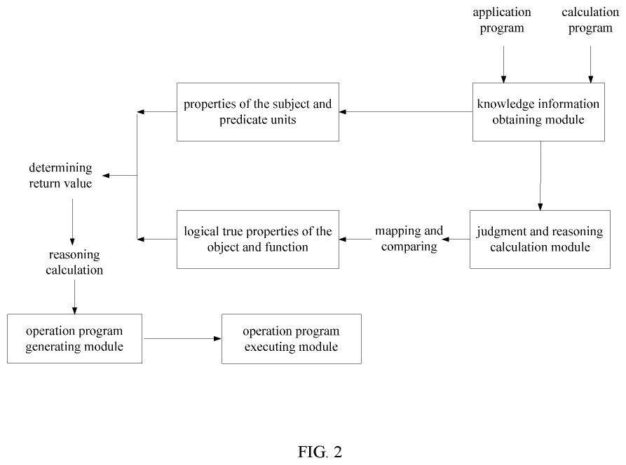

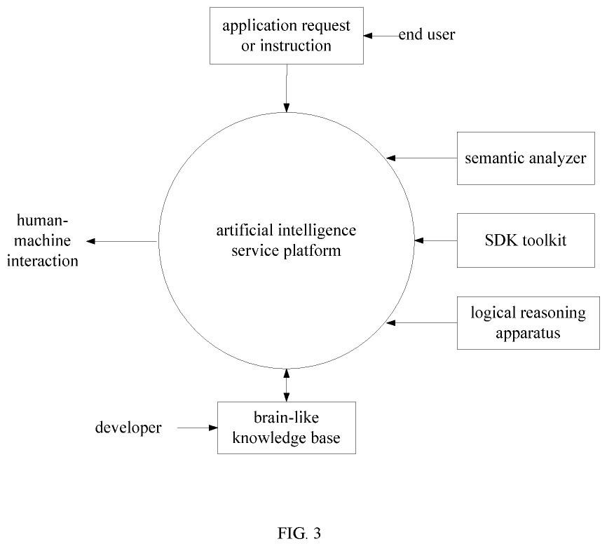

The technical solutions in the embodiments of the present disclosure will be described clearly and completely combining FIGS. 1 to 3. Obviously, the described embodiments are only a part of the embodiments of the present disclosure, but not all of them.

The present disclosure provide a method for computer simulation of human brain learning, including the following operations:

(1) establishing a brain-like knowledge library, the brain-like knowledge library including a word library, a class library, a resource library, and an intelligent information management library.

The word library is configured to store words that represent scenes or events in natural language and part of speech corresponding to the words.

The resource library is configured to store information resources of the scenes or the events, wherein the information resources correspond to the semantic properties of the class basic elements in the class library with logical true values.

The class library is configured to store class basic elements corresponding to syntax components in natural language sentences and logical properties corresponding to the subject and predicate units. The class basic element includes an object element and a function element. The logical property of the object element corresponding to the subject unit being positive is true, represented by a binary code 1. The logical property of the function element corresponding to the predicate unit being either positive or negative is true, respectively represented by a binary code 1 or 0. Herein, the binary code 1 refers to that the positive is true, and the binary code 0 refers to that the negative is true.

The intelligent information management library is configured to store a brain-like judgment and reasoning algorithm program and an intelligent application program, and a relation among the word library, the class library and the resource library.

(2) inputting the words representing grammatical components in the natural language sentences and the part of speech of the words in the word library; processing, by a semantic analyzer, a natural language single sentence to generate the class basic elements and the semantic properties in a manner of creating classes, and storing the class basic elements and the semantic properties in the class library; configuring the scenes corresponding to the class basic elements and the semantic properties, and storing the configured scenes in the resource library. The semantic properties of the objects and the functions being consistent with the properties of the corresponding scenes in the resource library is logical true. The property of the object element and the property of the corresponding scene being positive are logical true, the property of the function element and the property of the corresponding scene being either positive or negative are logical true. In addition, the function element with the semantic value of 1 corresponds to the scene that the property being positive is logical true, and the function element with the semantic value of 0 corresponds to the scene that the property being negative is logical true. By this way, the subject and the predicate units can correspond to the objects and functions, so as to form a basis for a computer to learn knowledge elements or morphemes in the brain-like manner.

(3) generating, by calling the semantic analyzer, an intelligent application program from a natural language program satisfying an intelligent application requirement, based on the class basic elements and the semantic properties in the class library, and storing the intelligent application program in the intelligent information management library; wherein the natural language program includes a natural language single sentence, a natural language compound sentence and a natural language sentence set. This is how computers learn sequential or systemic knowledge in the brain-like logical manner.

From the above, in accordance with the method for computer simulation of human brain learning knowledge, the brain-like knowledge library simulates memorizing and learning of human brain, which can be summarized into the following three levels:

The first is to learn concepts of the words and objective things they refer to, namely to learn knowledge of the scenes or the events represented by the words. For example, the relation between the word “sun” and the physical sun in the sky is the knowledge of this level. That is, a string of a particular word is used as a token to correspond to the scene or the event it represents. In the present disclosure, the knowledge is stored in the word library, the class library and the resource library, wherein the knowledge related to the words is stored in the word library, the knowledge related to the scenes is stored in the resource library (database), and the knowledge related to the operating and cognizing of the scenes or events is stored in the class library. In addition, these knowledge stored in the three libraries are in one-to-one correspondence with each other. By storing these knowledge in a computer, the computer is considered to have learned and memorized all these knowledge.

The second is to learn logical cognition and judgment knowledge formed by the subject and predicate concepts of sentences (also referred to statements), what can be what, and what cannot be what” and so on. In the brain-like brain knowledge base, this knowledge is expressed in the class library. The different syntactic components in a sentence are corresponding to the class basic elements, such as, the subject is represented as the object, the predicate is represented as the function or the attribute, and other components are represented as parameters, all of which correspond to the words in the word library and the scenes in the resource library. In addition, the subject and predicate units are defined corresponding to the subject and the predicate in a natural language sentence, and the semantic property of each of the logical units corresponds to the logical property of the scene represented by each of the logical units, so that the computer is capable to understand and judge knowledge in the brain-like manner. By storing this knowledge in the computer, the computer is considered to have learned and memorized all these knowledge.

The third is to learn the knowledge related to forming multiple single sentences into a complex sentence by using logical connectives and forming multiple compound sentences into a sentence set by using logical connectives. In the present disclosure, this knowledge is expressed to the application program that is executable by computers, and then stored in the intelligent information management library. In addition, this knowledge in the intelligent information management library is associated with those stored in the word library, the class library, and the resource library. By this way, the intelligent knowledge system, namely various intelligent application programs, can be generated by the analytical translation of the semantic analyser and the judgment and reasoning process of a logical reasoning apparatus. The specific translation method may refer to the Chinese Patent No. ZL201310657042.8, that is, to translate grammatical components, logical conjunctions, and logical semantics in natural language. Specifically, the string code representing the grammatical component is translated into a string code representing the name of the base element in the computer's object-oriented language; the logical connective is translated into a program transfer instruction code representing the program control; and the logical semantic is translated into a binary code representing positive and negative property. Then the three codes are stitched into an application program. In addition, the application program is generated to an executable intelligent program by the logical reasoning apparatus, so as to form the intelligent knowledge management system. Since machines store all the knowledge, they can be considered to have learned the intelligent knowledge so as to work according to the natural language. This may also be extended to the application that the computer can form knowledge by reading in or listening natural language.

The word library in the method includes a system word library, a private word library, and a public word library. The system word library is configured to store logical connectives and words with negative semantic properties. The private word library is configured to store user-defined words corresponding a specific field or corresponding the class library and the resource library in a specific field or block. The public word library is configured to store public words with normative part of speech. By this, the logically control words are strictly managed by the system, and the words representing general knowledge can be added and defined by users, so that knowledge block chain can be formed. It is conducive to reducing high resource consumption caused by big data analysis when the computer performs deep learning in the prior art, thereby preventing the monopoly of big data manufacturers, and also helps integration of knowledge in various fields by means of blocks, for better intelligent knowledge support and application.

The class library in the method includes an ontology heterogeneous function, which is configured to correspond different words referring to a same scene as a same word. This provides great convenience for the establishment of human-computer interaction platform based on natural language and its application, so that users can interact with computers with natural language in an easy and free manner.

Computer simulation of human brain learning refers to simulating human cognitive models and intelligent mechanisms into computer systems, so as to allow machines to have brain-like intelligence function. The establishment of the ontology-like brain knowledge base described above enables machines to have the brain-like learning manner and memory function.

The present disclosure also provides a logical reasoning apparatus, implemented in forms of software or hardware entities. The logical reasoning apparatus includes a knowledge information obtaining module, a judgment and reasoning calculating module, an operation program generating module, and an operation program executing module. The knowledge information obtaining module is configured to obtain the intelligent application program stored in the intelligent information management library and a judgment and reasoning algorithm program. The judgment and reasoning calculating module is configured to perform a logical judgment and reasoning calculation on the intelligent application program by the obtained axiom algorithm program. The operation program generating module is configured to generate an executable judgment and reasoning conclusion program according to a result of the logical calculation. The operation program executing module is configured to execute the judgment and reasoning conclusion program. These modules in the logical reasoning apparatus are combined together to realize the judgment and reasoning calculation, in which the sentence program is expressed by the subject and predicate units, and the program is controlled by the logical connective relations, such that the programming language derived from the natural language can be transferred to the executable application program, thereby providing an effective solution for application of the brain-like artificial intelligence.

Specifically, the judgment and reasoning algorithm program includes a judgment algorithm program. The judgment algorithm program when being executed is configured to judge whether a binary code of the semantic property of the function in a single sentence program is the same with a binary code of the logical property of the corresponding function in the class library. If the two are the same, such as 11 or 00, the single sentence program is judged to be true and returns a value of 1. Accordingly, the judgment conclusion of the single sentence program with the return value of 1 is made based on the object element, the function element and the corresponding scene, according to the original semantic property of the single sentence program. If the two are different, such as 10 or 01, the single sentence program is judged to be false and returns a value of 0. Accordingly, the judgment conclusion of the single sentence program with the return value of 1 is made based on the object element, the function element and the corresponding scene, according to the semantic property after reversing the original semantic property of the single sentence program.

The logical reliability and universal validity in the above process are intuitive. In the present disclosure, the semantic properties of the subject and predicate units in the programming language are compared with the properties of the corresponding subject and predicate units in the class library describing the real scenes, and this can be considered as a mapping between the subject-predicate concept and the real scene. If the two have the same property, then the programming language is determined to be true; if the two have different properties, then the programming language is determined to be false. In addition, if the programming language is determined to be true, then the judgment conclusion will be the same with the programming language; if the programming language is determined to be false, then the judgment conclusion will be different from the programming language. Because the logical property is either true of false, the opposite of the false is the true. As such, no matter the programming language to be judged is true of false, a judgment conclusion that is logically true can always be obtained. The intelligent program generating module generates the corresponding executable intelligent program according to the judgment conclusion that is logically true, so as to ensure the logical reliability of the program. Specifically:

The semantic properties corresponding to the subject and predicate units in the sentence program are compared with the logical true semantic properties of the objects and the functions in the class library, so as to obtain a judgement value. For example, suppose that the semantic properties of the subject and the predicate units in a sentence “Obama is the former president” are 11, the semantic properties 11 of the subject and the predicate units are compared with the logical true semantic properties 11 of the corresponding objects and functions in the class library, and accordingly the sentence is judged to be true, and returns with a judgement value of 1. This indicates that the sentence represented by the subject and predicate units is consistent with the real scene. For another example, suppose that the semantic properties of the subject and the predicate units in a sentence “Obama is not the former president” are 10, the semantic properties 10 of the subject and the predicate units are compared with the logical true semantic properties 11 of the corresponding object and function in the class library, and accordingly the sentence is judged to be false, and returns with a judgement value of 0. This indicates that the sentence represented by the subject and predicate units is not consistent with the real scene. The above calculation mode can be expressed as a formula:

jz⊙jw=jh=>(jz [symbol] jTz)⊙(jw [symbol] jTw)=j(jh)=jz⊙jw

wherein: h represents a propositional variable, j represents a semantic and logical property variable; jz and jw respectively represent a main and a predicate or an object and a function and their semantic properties; jTz and jTw respectively represent the real scene of the corresponding subject and the predicate and the properties logically true; ⊙ represents a XOR operator; and 0 represents a mapping operator. The above judgment calculation includes four kinds of encoding models, and the four kinds of encoding models exhaust all the computational models used by the human brain for proposition or sentence judgment. No matter the proposition is true or false, a conclusion that is judged to be true will be obtained after the calculation of any of the four encoding models. The encoding models enable the machine to simulate the judgmental thinking process of the human brain. The following gives calculation axioms of the four kinds of encoding models (label “=>” represents “judgment”).

Axiom 1: 1z⊙1w=1h=>(1z [symbol] 1Tz)⊙(1w [symbol] 1Tw)=1(1h)=1z⊙1w

For example, 1z corresponds to “Obama”, and 1w corresponds to “is the former president”. The proposition is judged to be true according to the axiom 1, and returns with a judgment value of 1. It indicates that the original semantic property of the predicate unit is logical true, namely, 1z Obama 1w is the former president.

Axiom 2: 1z⊙1w=1h=>(1z [symbol] 1Tz)⊙(1w [symbol] 0Tw)=0(1h)=1z⊙0w

For example, 1z corresponds to “Trump”, and 1w corresponds to “is the former president”. The proposition is judged to be false according to the axiom 2, and returns with a judgment value of 0. It indicates that the reversed original property of the predicate unit is logical true, namely, 1z Trump 0w is not the former president.

Axiom 3: 1z⊙0w=0h=>(1z [symbol] 1Tz)⊙(0w [symbol] 1Tw)=0(0h)=1z⊙1w

For example, 1z corresponds to “Obama”, and 0w corresponds to “is not the former president”. The proposition is judged to be false according to the axiom 3, and returns with a judgment value of 0. It indicates that the reversed original property of the predicate unit is true, namely, 1z Obama 1w is the former president.

Axiom 4: 1z⊙0w=0h=>(1z [symbol] 1Tz)⊙(0w [symbol] 0Tw)=1(0h)=1z⊙0w

For example, 1z corresponds to “Trump”, and 0w corresponds to “is not the former president”. The proposition is judged to be true according to the axiom 4, and returns with a judgment value of 1. It indicates that the original property of the predicate unit is true, namely, 1z Trump 0w is not the former president.

The axioms 1 and 2 are algorithms for calculating the positive propositions respectively true and false. The axioms 3 and 4 are algorithms for calculating the negative propositions respectively true and false. Because the subject and the predicate in each proposition take their strings as tokens and naturally correspond to the facts or scenes with unique properties, and the plurality of tokens have been defined by the ontology heterogeneous function synonyms for the same scene. Each proposition can be only have the positive or negative semantic property and the true or false logical property. For example, the 1(1h)=1z⊙1w in the axiom 1 indicates that if the judgment value of the positive proposition is true, then the proposition remaining unchanged is true; the 0(1h)=1z⊙0w in axiom 2 indicates that if the judgment value of the positive proposition is false, then the proposition is turned to be true after reversing the semantic property of the predicate unit; the 1(0h)=1z⊙0w in axiom 3 indicates that if the judgment value of the negative proposition is true, then the proposition remaining unchanged is true; and the 0(0h)=1z⊙1w in axiom 4 indicates that if the judgment value of the negative proposition is false, then the proposition is turned to be true after reversing the semantic property of the predicate. Therefore, the axioms 1 to 4 can logically satisfy the judgment calculation of any proposition. The subject and the predicate in the proposition correspond to the object and the function in the program, thus the axioms 1 to 4 can satisfy the logical judgment calculation of any sentence program.

The judgment and reasoning algorithm program also includes a reasoning algorithm program. The reasoning algorithm program when being executed is configured to derive a conclusion based on the return value of the single sentence program processed by the judgment algorithm program, and a logical connective relations. The logical connective relations include a sufficient condition, a necessary condition, a necessary and sufficient condition, AND, and OR. The manner for calculating the sufficient condition is as follows: if the return value of the antecedent single sentence is true, then the consequent single sentence is true; if the return value of the antecedent single sentence is false, then the consequent single sentence is true or false; if the return value of the consequent single sentence is true, then the antecedent single sentence is true or false; and if the return value of the consequent single sentence is false, then the antecedent single sentence is false. The manner for calculating the necessary condition is as follows: if the return value of the antecedent single sentence is true, then the consequent single sentence is true or false; if the return value of the antecedent single sentence is false, then the consequent single sentence is false; if the return value of the consequent single sentence is true, then the antecedent single sentence is true; and if the return value of the consequent single sentence is false, then the antecedent single sentence is true or false. The manner for calculating the necessary and sufficient condition is as follows: if the return value of the antecedent single sentence is true, then the consequent single sentence is true; if the return value of the antecedent single sentence is false, then the consequent single sentence is false; if the return value of the consequent single sentence is true, then the antecedent single sentence is true; and if the return value of the consequent single sentence is false, then the antecedent single sentence is false. The manner of calculating the OR relation is as follows: if one of the return values of two antecedent single sentences is true, then the other single sentence is false; and if one of the return values of the two antecedent single sentences is false, then the other single sentence is true. The manner of calculating the AND relation is as follows: if each of return values of the antecedent single sentences is true, then the consequent is true; and if one of the return values of the antecedent single sentences is false, then the consequent is false.

The operation program generating module is configured to generate the operation program according to a judgment and reasoning result calculated by the judgment and reasoning algorithm program. The manner of generating the judgment operation program is as follows: in response to the program having a return value of true, generating the judgment operation program based on the object, the function and the corresponding scene configured in the resource library, according to the original semantic property of the function; and in response to the program having a return value of false, generating the judgment operation program based on the object, the function and the corresponding scene configured in the resource library, according to the reversed semantic property of the function. The manner of generating the reasoning operation program is as follows: in response to the conclusion program having a return value of true, generating the reasoning operation program based on the corresponding object, the function and the scene configured in the resource library, according to the original semantic property of the function; in response to the conclusion program having a return value of false, generating the reasoning operation program based on the object, the function and the corresponding scene configured in the resource library, according to the reversed semantic property of the function; and in response to the conclusion program having a return value of true or false, generating the reasoning operation program based on the object, the function and the corresponding scene configured in the resource library, according to the original semantic property of the function or the reversed semantic property of the function.

The reasoning is a logical thinking manner deriving unknown based on known, which is the highest form of human brain thinking. The so-called known is that when solving a problem, the logical properties of the scenes are known. According to the sufficient condition, the consequent, namely the result, can be derived from the antecedent. This reliability and effectiveness rely on the inference rules of five kinds of logical relationships and their algorithms to establish an analysis program for a solved problem, including establishing a sufficient conditional premise by analysing the program, forming a logical relationship for deriving the follow-up with sufficient reason, and then drawing conclusions by judging the truth of the program sentence with sufficient reason. There are 5 rules or axioms for establishing analysis procedures and formulating conclusions for good reasons. Specifically:

(1) For the sufficient condition: if the antecedent h1 is assumed to be true, then the consequent h2 is true; and if the antecedent h1 is assumed to be false, then the subsequent h2 is true of false. In contrary, if the subsequent h2 is assumed to be true, then the antecedent h1 is true or false; and if the subsequent h2 is assumed to be false, then the antecedent h1 is true. The calculation can be expressed by a formula:

(jh1→jh2)→(1(jh1)→1(jh2))∨(0(jh1)←0V1(jh2))∨(1(jh2)←0V1(jh1))∧(0((jh2)→0(jh1))

(2) For the necessary condition: if the antecedent h1 is assumed to be true, then the consequent h2 is true or false; and if the antecedent h1 is assumed to be false, then the consequent h2 is false. In contrary, if the consequent h2 is assumed to be true, then the antecedent h1 is true; and if the consequent h2 is assumed to be false, then the antecedent h1 is true or false. The calculation can be expressed by a formula:

(jh1←jh2)→(1(jh1)←0∨1(jh2))∨(0(jh1)→0(jh2))∨(1(jh2)→1(jh1))∨0((jh2)←0∨1(jh1))

(3) For the necessary and sufficient condition: if the antecedent h1 is assumed to be true, then the consequent h2 is true; and if the antecedent h1 is assumed to be false, then the consequent h2 is false. In contrary, if the consequent h2 is assumed to be true, then the antecedent h1 is true; and if the consequent h2 is assumed to be false, then the antecedent h1 is false. The calculation can be expressed by a formula:

(jh1)↔(jh2)→(1(jh1→1(jh2))∨(0(jh1)→0(jh2))∨(1(jh2)→1(jh1))∨(0(jh2)→0(jh1))

(4) For the AND condition: only if each of the sentences in the antecedent is assumed to be true, then the subsequent is true; and if one of the sentences in the antecedent is false, then the subsequent is false. The calculation can be expressed by a formula:

jh1∧jh2→(1(jh1)∧1(jh2))→1(jh1∧jh2)∨(0(jh1)∧1(jh2))→0(jh1∧jh2))

(5) For the OR (XOR) condition: if any one of the antecedent and the consequent is assumed to be true, then the other is false; and vice versa. The calculation can be expressed by a formula:

(jh1∨jh2)→(1(jh1)→0(jh2))∨(0(jh1)→1(jh2))∨(1(jh2)→0(jh1))∨(0(jh2)→1(jh1))

It can be understood that since there include five logical relations of the brain-like judgment and reasoning, the above-mentioned reasoning manners can be used to process various logical connectives that may occur between statements. By compiling the natural language of the human brain to judge and reason into computer instructions or programs, the computer is made to have the judgment and reasoning intelligence. In addition, by executing the above program, the computer can obtain the result that is logically correct, thereby to satisfy application requirements. Examples are as follows:

Judgment Example 1: Trump is an American.

String say=“Trump is an American”;

listener.MatchListener (say); //JH platform monitoring

JHAaction jha=new JHAcation ( );

Semanteme semanteme=jha.JHSemanteme (say);

//receiving the grammatical elements of the sentence;

int zlj=semanteme.getZlj( ); //obtaining a logical value of the subject,

herein the value is 1;

int wlj=semanteme.getWlj( ); //obtaining a logical value of the predicate, herein the value is 1;

Int [ ] RLV=jha.getComparision (say); //obtaining the actual logical values for comparison, herein the actual logical value of the subject is 1, the actual logical value of the predicate is 1;

Boolean fal=LanguageComparisionEreality (zlj, wlj, RLV);

//determining the sentence to be true with a return value of 1 according to the comparison value between the sentence program and the scene; herein the positive is logical true, and accordingly the judgment conclusion is “Trump is an American”.

Judgment Example 2: Trump is Chinese.

String say =“Trump is Chinese”;

listener.MatchListener (say); //JH platform monitoring

JHAaction jha=new JHAcation ( );

Semanteme semanteme=jha.JHSemanteme (say);

//receiving the grammatical elements of the sentence;

int zlj=semanteme.getZlj( ); //obtaining a logical value of the subject, herein the value is 1;

int wlj=semanteme.getWlj( ); //obtaining a logical value of the predicate, herein the value is 1;

Int [ ] RLV=jha.getComparision (say); //obtaining the actual logical values for comparison, herein the actual logical value of the subject is 1, the actual logical value of the predicate is 0;

Boolean fal=LanguageComparisionEreality (zlj, wlj, RLV);

//determining the sentence to be true with a return value of 0 according to the comparison value between the sentence program and the scene; herein the property of the predicate needs to be reversed, and accordingly the judgment conclusion is “Trump is not Chinese”.

Reasoning Example 1 (sufficient condition): If Trump is an American, he is not Chinese.

String say=“If Trump is an American, he is not Chinese”;

JHAaction jha=new JHAcation ( );

Semanteme semanteme=jha.JHSemanteme (say);

String JudgeConditions=semanteme.getqj( ); //obtaining the antecedent is the “Trump is an American”;

Through Example 1, the return value is 1, and thus the subsequent is true. That is, if the antecedent in the sufficient condition is true, then the subsequent is true. Accordingly, the judgement conclusion is: Because Trump is an American, he is not Chinese.

Reasoning Example 2 (necessary condition): Only if Trump is not an American, he is Chinese.

String say=“Only if Trump is not an American, he is Chinese”;

JHAaction jha=new JHAcation ( );

Semanteme semanteme=jha.JHSemanteme (say);

String JudgeConditions=semanteme.getqj( ); //obtaining the antecedent is the “Trump is not an American”;

Through Example 1, the return value is 0, and thus the subsequent is false. That is, if the antecedent in the necessary condition is false, then the subsequent is false. The sentence determined to be false is turned to be true after reversing the property of the predicate. Accordingly, the judgement conclusion is: Because Trump is an American, he is not Chinese.

Reasoning Example 3 (sufficient and necessary condition): If the caliber of the cup is 5 cm, the cup is qualified.

String say=“If the caliber of the cup is 5 cm, the cup is qualified.”;

JHAaction jha=new JHAcation ( );

Semanteme semanteme=jha.JHSemanteme (say);

String JudgeConditions=semanteme.getqj( ); //obtaining the antecedent is the “the caliber of the cup is 5 cm”;

Through Examples 1 and 2, because the actual caliber of the cup may be equal to 5 cm or not, the actual caliber may not be the same as the standard caliber. There include two kinds of return values, namely 1 or 0. When the return value is 1, the correct conclusion is “The cup is qualified”. That is, if the antecedent in the sufficient and necessary condition is true, then the subsequent is true; and accordingly, the property of the predicate remains unchanged. When the return value is 0, the correct conclusion is “The cup is not qualified”. That is, if the antecedent in the sufficient and necessary condition is false, then the subsequent is false; and accordingly, the property of the predicate needs to be reversed.

From above, the logical reasoning apparatus can derive real information that matches the scenes, thereby ensuring that the generated executable program is able to simulate the brain-like judgment and reasoning. In addition, the logical reasoning apparatus can connect the scenes of various logical relations to form a more complex judgment and reasoning process, which better realize the computer simulation of human brain learning knowledge.

The present disclosure further discloses a brain-like artificial intelligence service platform, including:

(1) integrating a semantic analyser, a method for computer simulation of human brain described above and the logical reasoning apparatus into a common intelligence tool, creating the brain-like artificial intelligence service platform, so as to provide network sharing brain-like service;

(2) downloading, by an artificial intelligence application developer, a SDK toolkit from the brain-like artificial intelligence service platform, and establishing or updating the brain-like knowledge library and an intelligent application program by using the method for computer simulation of human brain learning knowledge;

(3) sending, by an end user, an application request or instruction to the brain-like artificial intelligence service platform in natural language based on an application product of the artificial intelligence developer;

(4) obtaining, by the brain-like artificial intelligence service platform, the natural language input by the end user, and generating an application request or instruction of the artificial intelligence application developer by calling the semantic analyser; and

(5) processing, by calling the logical reasoning apparatus, the intelligent application program provided by the artificial intelligence application developer.

The present disclosure utilizes the network cloud platform to integrate the semantic analyzer, the method for computer simulation of human brain and the logical reasoning apparatus into an intelligent operating system based on a natural language complier, thereby realizing wide application of brain-like artificial intelligence. Different artificial intelligence developers can access the AI brain intelligence tools and their operating systems via the human-computer interaction cloud platform interface, and develop the ontology brain-like knowledge library and related intelligent products by taking advantage of the brain-like ability of the brain-like artificial intelligence service platform. End users of artificial intelligence products can also interact with the computer through the human-computer interaction cloud platform interface, so that the brain-like artificial intelligence system based on the human-computer interaction cloud service platform can be formed. In the present disclosure, the method for computer simulation of human brain learning knowledge simulates the cognition model of the human brain, the logical reasoning apparatus simulates the intelligent mechanism of the human brain, and the artificial intelligence platform provides the intelligence function that the computer can simulate the communication between people.

The foregoing description merely portrays some illustrative embodiments in accordance with the disclosure and therefore is not intended to limit the patentable scope of the disclosure. Any equivalent structure or flow transformations that are made taking advantage of the specification and accompanying drawings of the disclosure and any direct or indirect applications thereof in other related technical fields shall all fall in the scope of protection of the disclosure.

1. A method for computer simulation of human brain learning knowledge, comprising:
(1) establishing a brain-like knowledge library, the brain-like knowledge library comprising a word library, a class library, a resource library, and an intelligent information management library; wherein:
the word library is configured to store words that represent scenes or events in natural language and part of speech corresponding to the words;
the class library is configured to store class basic elements corresponding to syntax components in natural language sentences and logical true sematic properties of the class basic elements, wherein:
the natural language sentences comprise subject units and predicate units, and the class basic elements comprise objects and functions; the semantic property of the object element corresponding to the subject unit being positive is logical true, represented by a binary code 1; the semantic property of the function element corresponding to the predicate unit being either positive or negative is logical true, respectively represented by a binary code 1 or 0; the binary code 1 refers to that the positive is true, and the binary code 0 refers to that the negative is true;
the resource library is configured to store information resources of the scenes or the events, wherein the information resources correspond to the semantic properties of the class basic elements in the class library with logical true values; and
the intelligent information management library is configured to store a brain-like judgment and reasoning algorithm program and an intelligent application program, and a relation among the word library, the class library and the resource library;
(2) inputting the words representing grammatical components in the natural language sentences and the part of speech of the words in the word library; processing, by a semantic analyzer, a natural language single sentence to generate the class basic elements and the semantic properties in a manner of creating classes, and storing the class basic elements and the semantic properties in the class library; configuring the scenes corresponding to the class basic elements and the semantic properties, and storing the configured scenes in the resource library, wherein:
the semantic properties of the objects and the functions being consistent with the properties of the corresponding scenes in the resource library is logical true; the property of the scene corresponding to the object element being positive is logical true, the property of the scene corresponding to the function element being either positive or negative is logical true; the function element that the semantic property is represented by the binary code 1 corresponds to the scene that the property being positive is logical true, and the function element that the semantic property is represented by the binary code 0 corresponds to the scene that the property being negative is logical true, so as to form a correspondence relationship between the subject and predicate units and the objects and functions;
(3) generating, by the semantic analyzer, the intelligent application program satisfying an intelligent application requirement from a natural language program based on the class basic elements and the semantic properties in the class library, and storing the intelligent application program in the intelligent information management library, wherein the natural language program comprises a natural language single sentence, a natural language complex sentence, or a natural language sentence set.

2. The method for computer simulation of human brain learning knowledge according to claim 1, wherein the word library comprises a system word library, a private word library, and a public word library; wherein:
the system word library is configured to store logical connectives and words with negative semantic properties;
the private word library is configured to store user-defined words corresponding to the class library and the resource library in a specific field or block; and
the public word library is configured to store words with normative part of speech.

3. The method for computer simulation of human brain learning knowledge according to claim 1, wherein the class library comprises an ontology heterogeneous function, configured to correspond different words referring to a same scene as a same word.

4. A logical reasoning apparatus, applying to the method for computer simulation of human brain learning knowledge according to claim 1, in forms of software or hardware, comprising a knowledge information obtaining module, a judgment and reasoning calculating module, an operation program generating module, and an operation program executing module; wherein:
the knowledge information obtaining module is configured to obtain an application program in an intelligent information management library and an algorithm program that is configured to perform a judgment and reasoning calculation on the application program;
the judgment and reasoning calculating module is configured to perform the judgment and reasoning calculation on the application program by using an obtained axiom algorithm program;
the operation program generating module is configured to generate an executable judgment and reasoning conclusion program according to a result of a logical calculation; and
the operation program executing module is configured to execute the judgment and reasoning conclusion program.

5. The logical reasoning apparatus according to claim 4, wherein the judgment and reasoning algorithm program comprises a judgment algorithm program and a reasoning algorithm program; wherein:
the judgment algorithm program is configured to judge whether a binary code of the semantic property of the function in a single sentence program and a binary code of the logical true semantic property of the corresponding function in the class library are the same; wherein:
in response to a determination that the binary code of the semantic property of the function in the single sentence program and the binary code of the logical true semantic property of the corresponding function in the class library are the same of 11 or 00, the single sentence program is judged to be true and returns a value of 1; a judgment conclusion of the single sentence program with the return value of 1 is made based on the object, the function and the information resource of the corresponding scene, according to the original semantic property of the single sentence program;
in response to a determination that the binary code of the semantic property of the function in the single sentence program and the binary code of the logical true semantic property of the corresponding function in the class library are different of 10 or 01, the single sentence program is judged to be false and returns a value of 0; a judgment conclusion of the single sentence program with the return value of 0 is made based on the object, the function and the information resource of the corresponding scene, according to a semantic property after reversing the original semantic property of the single sentence program; and
the reasoning algorithm program is configured to derive a conclusion based on the return value of the single sentence program processed by the judgment algorithm program and a logical connective relation, wherein the logical connective relation comprises a sufficient condition, a necessary condition, a necessary and sufficient condition, AND, and OR.

6. The logical reasoning apparatus according to claim 5, wherein:
the reasoning algorithm program when being executed to calculate the sufficient condition performs the following operations: if an antecedent is true, determining a consequent to be true; if the antecedent is false, determining the consequent to be true or false; if the consequent is true, determining the antecedent to be true or false; and if the consequent is false, determining the antecedent to be false;
the reasoning algorithm program when being executed to calculate the necessary condition performs the following operations: if the antecedent is true, determining the consequent to be true or false; if the antecedent is false, determining the consequent to be false; if the consequent is true, determining the antecedent to be true; and if the consequent is false, determining the antecedent to be true or false; and
the reasoning algorithm program when being executed to calculate the necessary and sufficient condition performs the following operations: if the antecedent is true, determining the consequent to be true; if the antecedent is false, determining the consequent to be false; if the consequent is true, determining the antecedent to be true; and if the consequent is false, determining the antecedent to be false.

7. The logical reasoning apparatus according to claim 5, wherein the reasoning algorithm program when being executed to calculate the OR relation performs the following operations:
if one of two single sentences is true, determining the other one of the two single sentences to be false; and if one of the two single sentences is false, determining the other one of two single sentences to be true.

8. The logical reasoning apparatus according to claim 5, wherein the reasoning algorithm program when being executed to calculate the AND relation performs the following operations:
if each of single sentences in an antecedent is true, determining a consequent to be true; and if one of the single sentences in the antecedent is false, determining the consequent to be false.

9. The logical reasoning apparatus of claim 4, wherein the operation program generating module is configured to generate an operation program according to a judgment and reasoning conclusion;
generating a judgment operation program comprises the following operations:
in response to the function having a return value of true, generating the judgment operation program based on the object and the function in the class library, and the corresponding scene configured in the resource library, according to the original semantic property of the function defined in the intelligent application program;
in response to the function having the return value of false, generating the judgment operation program based on the object and the function in the class library, and the corresponding scene configured in the resource library, according to a semantic property after reversing the semantic property of the function defined in the intelligent application program;
wherein the program comprises a plurality of single sentences, and the plurality of single sentences are processed in a certain order to generate the judgment operation program; and
generating a reasoning operation program comprises the following operations:
dividing an application program of a reasoning relation into an analysis program statement and an operation program statement;
in response to a program having a conclusion value of true, generating the reasoning operation program based on the object and the function in the class library, and the corresponding scene configured in the resource library, according to the original semantic property of the function defined in the intelligent application program;
in response to the program having the conclusion value of false, generating the reasoning operation program based on the object and the function in the class library, and the corresponding scene configured in the resource library, according to the semantic property after reversing the semantic property of the function defined in the intelligent application program; and
in response to the program having the conclusion value of true or false, generating the reasoning operation program based on the object and the function in the class library, and the corresponding scene configured in the resource library, according to the original semantic property of the function defined in the intelligent application program or the semantic property after reversing the semantic property of the function defined in the intelligent application program.

10. A brain-like artificial intelligence service platform, applying the logical reasoning apparatus according to claim 4, comprising:
(1) integrating a semantic analyzer, the method for computer simulation of human brain learning knowledge, and the logical reasoning apparatus into an intelligence operating system based on natural language analyzer, and developing the brain-like artificial intelligence service platform, to provide network sharing brain-like service;
(2) downloading, by an artificial intelligence application developer, a toolkit from the brain-like artificial intelligence service platform, establishing or updating the brain-like knowledge library and an application program by applying the method for computer simulation of human brain learning knowledge;
(3) sending, by an end user, an application request or instruction to the brain-like artificial intelligence service platform in natural language based on an application product of the artificial intelligence developer;
(4) obtaining, by the brain-like artificial intelligence service platform, the natural language input by the end user, and generating the application request or instruction defined by the artificial intelligence application developer by calling the semantic analyzer; and
(5) processing, by the logical reasoning apparatus, the intelligent application program satisfying a requirement of the end user, to finish human-machine interaction.

11. The logical reasoning apparatus according to claim 4, wherein the word library comprises a system word library, a private word library, and a public word library; wherein:
the system word library is configured to store logical connectives and words with negative semantic properties;
the private word library is configured to store user-defined words corresponding to the class library and the resource library in a specific field or block; and
the public word library is configured to store words with normative part of speech.

12. The logical reasoning apparatus according to claim 4, wherein the class library comprises an ontology heterogeneous function, configured to correspond different words referring to a same scene as a same word.

13. The brain-like artificial intelligence service platform according to claim 10, wherein the word library comprises a system word library, a private word library, and a public word library; wherein:
the system word library is configured to store logical connectives and words with negative semantic properties;
the private word library is configured to store user-defined words corresponding to the class library and the resource library in a specific field or block; and
the public word library is configured to store words with normative part of speech.

14. The brain-like artificial intelligence service platform according to claim 10, wherein the class library comprises an ontology heterogeneous function, configured to correspond different words referring to a same scene as a same word.
